(19) United States
(12) Patent Application Publication
(10) Pub. No.: US 2011/0308989 A1
(43) Pub. Date: Dec. 22, 2011

(54) COMPOSITE COOKWARE COMPRISING A VITREOUS PROTECTIVE COATING

(75) Inventors: Aurélien Berrux, La Motte Servolex (FR); Gaëlle Barcikowski, Rumilly (FR)

(73) Assignee: SEB SA, Ecully (FR)

(21) Appl. No.: 13/142,137

(22) PCT Filed: Dec. 23, 2009
(86) PCT No.: PCT/IB2009/007973

§ 371 Date: Sep. 9, 2011

(30) Foreign Application Priority Data
Dec. 24, 2008 (EP) 08172937.8

(51) Int. Cl. A47J 37/10; B05D 3/02

(52) U.S. Cl. 206/524.3; 427/327

(57) ABSTRACT

A composite cookware for food preparation and process for manufacturing composite cookware. The composite cookware includes a metallic composite support element, the outer surface of which is covered by a vitreous protective coating. The protective coating is a continuous film having a thickness of at least 10 μm and formed of a sol-gel material including a matrix of at least one polyalcoxysilane and at least one metal oxide dispersed in the matrix.

### FIELD OF THE INVENTION

The present invention relates to a composite cookware for food preparation, comprising a metallic composite support element, the outer surface of which is covered by a vitreous protective coating. The present invention also relates to a process for manufacturing such a cookware.

### BACKGROUND OF THE INVENTION

Organic paints are often used as decorative coatings on the outer surface of a cookware. However, the use of organic paints suffers from the major drawback that they can only be applied on the side wall of the cookware, since the contact of organic paints with a heat source is proscribed.

Vitreous coatings such as enamel coatings are often used for protecting metal substrates such as steel. However, enamel coatings are generally produced by processes involving a heating step to firing temperature that is generally higher than 800° C. for enameling steel substrates.

Thus, it is no possible to use the enamels generally used on steel substrates for enameling the stainless steel layer of a multi-ply metal support which also comprises an aluminum layer, since aluminum has a melting temperature of about 660° C.

By aluminum, it is meant in embodiments of the present invention pure aluminum or an aluminum alloy.

One solution to this problem posed is therefore to propose a vitreous protective coating, which process involves a heat treatment to be carried up to an end temperature below 650° C.

A process is known from U.S. Pat. No. 6,162,498 and US 2008/0118745 for providing a metallic surface with a vitreous layer, which is decorative, scratch resistant and corrosion inhibiting. Said process comprises:

the preparation of a coating composition by hydrolizing and polycondensing one or more silanes in the presence of micronized SiO₂ particles and at least one compound selected from the group consisting of the oxides and hydroxides of the alkali and alkaline earth metals,

the application of the coating composition to the metallic surface to form a coating, and

the thermally densification of the coating to form a vitreous layer, this step being preferably preceded by a drying operation.

In the process of U.S. Pat. No. 6,162,498, the thermal densification consists in curing the coating at an end temperature ranging from 350° C. to 500° C., in the case of stainless steel substrates.

It is also known from US 2008/0118745 metallic substrates such as steel or aluminum having a deformable glass-type coating, obtainable by a process comprising:

a) the application of an alkali metal silicate-containing coating sol to the substrate, to provide a coating layer, and

b) the thermal densification of the coating layer by a two-stage heat treatment, preferably at en end temperature of up to about 500° C.

In the first stage, the heat treatment is carried out either in (A) an oxygen-containing atmosphere, preferably at an end temperature of up to about 400° C., or (B) in a vacuum at a residual pressure lower than 15 mbar, preferably in an inert gas atmosphere. In the second stage, the heat treatment is preferably carried out at an end temperature in a range of from 400° C. to 600° C.

In U.S. Pat. No. 6,162,498 and in US 2008/0118745, the metallic surfaces to be coated are surfaces consisting or comprising a metal (such as aluminum) or a metal alloy (such as steel, notably stainless steel and aluminum alloys).

However, nothing is said in US 2008/0118745 and U.S. Pat. No. 6,162,498 relative to multi-ply composite substrates comprising an outer layer of stainless steel and at least one inner layer of a metal or a metal alloy having a melting temperature lower than 650° C. (such as aluminum or aluminum alloy), nor relative to the problems encountered by such substrates when they are provided with a vitreous layer obtained by the sol-gel route. Indeed, a multi-ply metal composite support has the drawback of warping during use, due to the differences in thermal expansion properties of the different bonded materials of the composite support. This thermal effect can cause a fine stress cracking of the vitreous coating deposited on the stainless steel layer of the composite element.

There remains a need for a composite cookware comprising a vitreous coating adapted to a composite element support made of a stainless steel layer and a layer of a metal or metal alloy having a melting point lower than 650° C.

### SUMMARY OF THE INVENTION

One solution to this problem is a composite cookware for a food preparation, comprising a hollow support element defining a bottom and a side wall rising from the bottom, said support having an inner surface adapted to be oriented towards the food to be disposed in the cookware and an outer surface adapted to be oriented downwardly towards a heat source, said outer surface being overlaid by a protective coat, wherein:

the protective coat is a continuous film having a thickness of at least 10 μm and formed of a sol-gel material, comprising a matrix of at least one polyalcoxysilane and at least one metal oxide dispersed in said matrix, said sol-gel material having a coefficient of expansion α, which ranges from 50.10⁻⁷ to 100.10−⁷ K⁻¹;

said support element is a composite element comprising an outer layer of stainless steel having said outer surface, and at least an inner layer of a metal or a metal alloy having a melting temperature lower than 650° C., said inner layer being bonded to the outer layer of stainless steel.

By cookware, it is meant in embodiments of the present invention all types of food preparation containers commonly found in the kitchen, notably cooking vessels such as saucepans and frying pans adapted for use on a stove or range cooktop, and also cooking vessels adapted for use inside an oven (bakeware).

The vitreous protective coating according to embodiments of the invention is durable, and thus, does not need to be often changed.

The vitreous coating according to embodiments of the invention also presents the advantage to be well adapted to composite element supports, since its coefficient of expansion is only slightly lower than that of the outer stainless steel layer of the composite element support. Thus, the vitreous coating is slightly compressed on the outer stainless steel layer, which notably reduces the risk of forming fine cracks or crazing on said vitreous coating and enhances the quality of this coating.

Furthermore, if the vitreous coating according to embodiments of the invention must contain a red pigment, it is possible to use a mineral pigment, since such a pigment can lead to a vitreous coating having a red color similar to that traditionally obtained with cadmium pigments for colouring ceramic glazes and glass. However, cadmium pigments present the major drawback of being toxic. On the contrary, the red mineral pigment contained in the vitreous coating of the invention is not toxic and completely safe for the environment.

A colored sol-gel coating according to embodiments of the invention has a very uniform red color and exhibits only a slight discoloration when used in the dishwashers (corrosion resistance).

Furthermore, the coating according to embodiments of the invention both exhibits an intense coloration and transparency.

This intense and uniform coloration of the coating according to embodiments of the invention, combined with transparency are only rendered feasible because of a thickness of at least 10 μm.

If the thickness is below 10 μm, it is necessary to significantly increase the density of pigments in the coating for having a sufficient coloration and uniformity. However, in that case, the coating is not transparent.

Furthermore, the presence of pigments in the sol-gel coating enhances the scratch-resistance of the sol-gel coating according to embodiments of the invention.

In one embodiment, the metal oxide is a micronized oxide.

In one particular embodiment of the present invention, the inner layer of the support element is a layer of pure aluminum or aluminum alloy. In such an embodiment, the composite element is thus constituted by a stainless steel layer bonded to a layer of aluminum or aluminum layer. This embodiment allows an excellent heat distribution and conductivity properties, and thus provides a thermally efficient and durable cookware.

In a further embodiment, the inner layer of the support element is further bonded to a second layer of stainless steel. Then, in the particular case of a support element being a multi-ply composite element in which the outer layer completely covers the inner layer (including the side wall of the support element), said inner layer is thus a core layer sandwiched between two layers of stainless steel. This embodiment enhances the above-mentioned properties of heat distribution and conductivity.

In another embodiment of the present invention, the outer stainless steel layer of is a ferromagnetic grade, and more particularly a ferritic grade, adapted to render the cookware suitable for an induction heating.

Within this context of an outer stainless steel layer being a ferromagnetic grade, the outer layer can also be a plate centred on the bottom of the cookware and only covering the portion of the inner layer defined by said bottom.

Then, the cookware according to embodiments of the invention has an improved scratch resistance as well as improved resistance to detergents used in dishwashers.

Another goal according to embodiments of the present invention includes methods for manufacturing a composite cookware for a food preparation, which enables the realization of a dense enamel type coating on the stainless steel layer of a composite support which further comprises an inner layer of aluminum (or aluminum alloy), by avoiding a heat treatment at temperatures higher than the melting point of aluminum.

For this, a method for manufacturing a composite cookware for a food preparation can include:
providing a hollow support element defining a bottom and a side wall rising from said bottom, this support element having an inner surface adapted to be oriented towards the food to be disposed in the cookware and an outer surface adapted to be downwardly oriented towards a heat source;
preparing a coating composition;
coating at least a portion of the outer surface of the support element with the coating composition, to form a green protective coating on said outer surface; and
thermally densifying the green protective coating, to form a transparent vitreous protective coating on said outer surface;

wherein:
the metal support element is a multi-ply composite element comprising an outer layer of stainless steel having said outer surface, and an inner layer of a metal or a metal alloy having a melting temperature below 650° C., said inner layer being bonded to said outer layer;
the coating composition is prepared by a process comprising hydrolyzing and polycondensing at least one silane of the general formula:

RₙSiX₄₋ₙ

where:
each R, which are the same or different, is hydrogen or an optionally fluorinated alkyl, alkenyl, or alkynyl group having up to 12 carbon atoms, or an optionally fluorinated aryl, aralkyl, or alkaryl group having 6 to 10 carbon atoms,
each X, which are the same or different, is a hydrolyzable group or a hydroxyl group, and
n is 0, 1 or 2, provided that at least one silane has n=1 or 2, or one or more oligomers derived therefrom, in the presence of at least one metal oxide and at least one melting agent selected in the group consisting of the ethoxides, oxides and hydroxides of the alkali and alkaline earth metals and the boron trimethoxide wherein the weight ratio of the total Si in the silanes to the melting agent is between 5 and 20; and
the step of thermally densifying the protective coating is carried out at an end temperature ranging between 400° C. and 600° C., and more particularly between 450° C. and 500° C.

The outer layer can be a plate, such as, for example, of ferromagnetic grade, centered on the bottom of the cookware. Then, in this particular case, the plate can be applied by stamping to the inner layer.

### BRIEF DESCRIPTION OF THE DRAWINGS

Other advantages and particular features of the invention will emerge from the description that follows, and which is provided with reference to the appended figures, in which:

FIG. 1 represents a cross-sectional schematic view of a culinary item according to a first variant of the invention,

FIG. 2 represents a cross-sectional schematic view of a culinary item according to a second variant of the invention, and

FIG. 3 represents a cross-sectional schematic view of a culinary item according to a third variant of the invention,

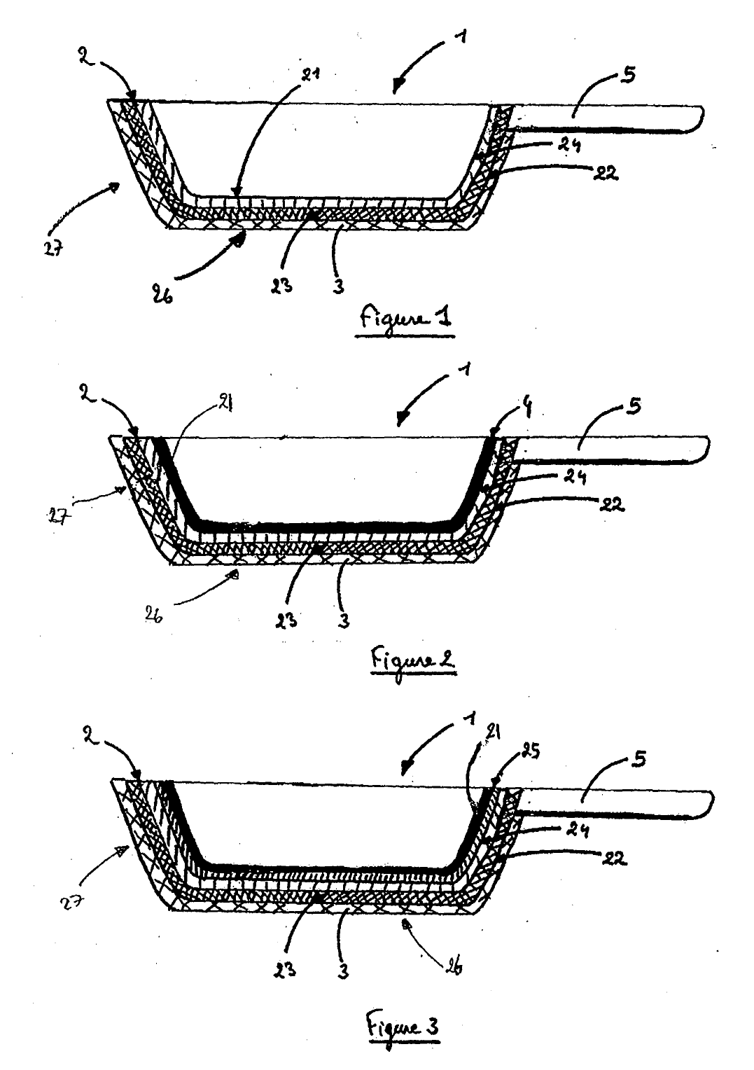

Elements common to FIGS. 1 to 3 are identified by the identical numerical references.

### DETAILED DESCRIPTION OF THE DRAWINGS

In FIGS. 1 to 3, there is shown, by way of illustration, a frying pan 1. This frying pan 1, includes a gripping handle 5 for grasping and one piece support element 2, comprising a bottom 26 and lateral wall 27 rising up from said bottom 26. The support element 2 includes an inner surface 21 which is adapted to be oriented towards the food to be disposed in the cookware, and an outer surface 22, which is adapted to be oriented towards a heat source (such a burner).

Referring now more particularly to the support element 2, it is a multi-ply composite support comprising a very thin layer 23 of stainless steel comprising the outer surface 22, and a thicker layer of aluminum 24 bonded to the stainless steel layer 21. The stainless steel layer 23 can be a ferromagnetic grade (such as a ferritic grade) or an austenitic stainless steel, although a ferromagnetic grade is preferred if the frying-pan 1 is to be induction heated.

The aluminum layer 24 can be pure aluminum, Alclad aluminum or aluminum alloys chosen from 3003 aluminum alloy, 4006 aluminum alloy and 4700 aluminum alloy.

The outer layer 23 of stainless steel, which can include either a brushed or a sandblasted finish on the outer surface 22, is at least partially covered by a protective coat 3. In one embodiment, this protective coat covers the entire outer surface 22 of the support element 2, namely the stainless-steel layer 23.

According to embodiments of the present invention, the protective coat 3 is in the form of a continous film of s sol-gel material having a thickness of at least 10 μm, and particularly between 10 μm and 15 μm.

This sol-gel material comprises a matrix of at least one polyalcoxysilane and at least one metal oxide, which is dispersed in the polyalcoxysilane matrix.

Suitable sol-gel materials to be applied to the outer surface 22 of the surface element are sol gel materials which must have an expansion coefficient ranging from 50.10⁻⁷ to 100.10⁻⁷ K⁻¹. Metal oxides which can be used in the sol-gel material in accordance with embodiments of the present invention include silica, alumina, zircon oxide, vanadium oxide, and cerium oxide. In one particular embodiment, the metal oxide is silica.

The sol-gel material in accordance with embodiments of the present invention may can also contain one or more mineral pigments, which can be in the form of micronized or submicronized pigments.

Mineral pigments that can be used in the sol-gel material according to embodiments of the invention mention include metal oxides, spinels, flakes of mica or flakes of alumina in which said flakes are covered by metal oxides. In one particular embodiment, the pigment is the red mineral pigment IRIODIN® of the MERCK Company.

Metal oxides that can be used as pigments in the protective coat of embodiments of the invention include titanium oxide (TiO₂) and/or iron oxide (Fe₂O₃).

Flakes that can be used as pigments in the protective coat include the flakes covered by metal oxides such as oxides of zircon, titanium or zinc.

Referring now to FIG. 2, the frying pan 1 illustrated in this figure further comprises a nonstick layer 4 applied to the inner surface 21 of the support element 2.

This non-stick layer can advantageously be constituted by a coating comprising a sintered network of at least one thermostable resin withstanding a temperature of at least 200° C.

Thermostable resins withstanding a temperature of at least 200° C. that can be used in embodiments of the present invention include fluorocarboned resins, that can be used alone or blended with one or more other thermostable resins withstanding a temperature of at least 200° C., such as silicone resins.

Fluorocarboned resins that can be used in embodiments of the present invention include polytetrafluoro ethylene (PTFE), tetrafluoroethyleneaperfluoropropylvinyletheracopoly-mer (PFA) or tetrafluoroethylene-hexafluoropropylene copolymer (FEP) or a blend of these fluorocarboned resins.

Other thermostable resins whithstanding to at least 200° C. can include a polyamide imide (PAI), a polyethylene sulfone (PES), a polyphenylene sulphide (PPS), a polyetherketone (PEK), a polyether-etherketone (PEEK) or a silicone.

In the alternative illustrated in FIG. 3, the support element 2 comprises 3 bonded layers, disposed as follows:
an outer layer 23 of stainless steel, comprising the outer surface 22 of the support element 2,
a core layer 24 of pure aluminum o aluminum alloy, and
an inner layer 25 of stainless steel.

The stainless-steel outer layer 23 is as described above and similar to the stainless steel layer 23 of the embodiments illustrated in FIGS. 1 and 2.

In a similar manner, the core layer 24 of pure aluminum or aluminum alloy is that described above and similar to the aluminum inner layer 24 of the embodiments illustrated in FIGS. 1 and 2.

The stainless-steel inner layer 25 of the composite support element 22, illustrated in FIG. 3, can be an austenitic grade, particularly in the 300 series (such as type 304).

Methods according to embodiments of the invention for producing a culinary item 1 for a food preparation will now be detailed.

This method includes the following consecutive steps read in reference to FIGS. 1 and 3:
providing a multi-ply composite support element 2 defining an inner surface 21 adapted to be oriented the food to be disposed in the cookware 1, and an outer surface 22 adapted to be downwardly oriented towards a heat source, the support element 2 comprising an outer layer 23 of stainless steel having said outer surface 22, and an inner layer 24 of a metal or a metal alloy having a melting temperature below 650° C.;
preparing a coating composition;
applying to at least a portion of the outer surface 22 of the support element 2 the coating composition, to form a green protective coating 4 on said outer surface 22; and
thermally densifying the green protective coating 3, to form a transparent vitreous protective coating 4 on said outer surface 22.

By green coating, it is meant in embodiments of the present invention, a non-cured coating.

As already indicated above, the outer layer of stainless steel of the embodiments illustrated in FIGS. 1 to 3 comprises the outer surface 22 of the support element 2. Said outer surface 22 of the support element 2, which is covered at least partially by the protective coat 3, functions as the heat-source contacting surface.

As regards the embodiment illustrated in FIG. 1, the support element 2 is a bi-ply composite element constituted by the outer layer 23 of stainless steel and one inner layer 24 of pure aluminum or aluminum alloy. Thus, in this embodiment, the layer 24 of aluminum (pure or alloyed) comprises the inner surface 21 of the biply composite element 2, which functions as the food contacting surface.

As regards the embodiment illustrated in FIG. 3, the support element 2 is a three-ply composite element constituted by the outer layer 23 of stainless steel, one core layer 24 of aluminum (pure or alloyed) bonded to the outer layer 23, and an inner layer 25 of stainless steel bonded to the inner aluminum layer 24. Thus, the second stainless-steel layer 25 comprises the inner surface 21 of the triply composite element 2, which functions, as indicated above, as the food contacting surface.

In the embodiment, illustrated in FIGS. 1 and 3, the different metal layers of the composite support element 2 are as described above.

According to the method of the invention, the preparation of the coating composition comprises hydrolyzing and polycondensing at least one silane of the general formula:

R—SiX₄₋ₙ

where:
each R, which are the same or different, is hydrogen or an optionally fluorinated alkyl, alkenyl, or alkynyl group having up to 12 carbon atoms, or an optionally fluorinated aryl, aralkyl, or alkaryl group having 6 to 10 carbon atoms,
each X, which are the same or different, is a hydrolyzable group or a hydroxyl group, and
n is 0, 1 or 2, provided that at least one silane has n=1 or 2, or one or more oligomers derived therefrom, in the presence of at least one metal oxide and at least one melting agent selected in the group consisting of the oxides and hydroxides of the alkali and alkaline earth metals and the boron trimethoxide, wherein the weight ratio of the total Si in the silanes to the melting agent is between 5 and 20.

In one embodiment, the metal oxide is a micron-oxide.

Prior to the application of the coating composition, the portion of the outer surface 22, that is adapted to be overlaid by said coating composition, can be thoroughly cleaned (particularly free of grease and dust), and then carried out by a prior mechanical or chemical treatment.

In one embodiment, the surface treatment is a mechanical one, such as brushing or sandblasting the outer surface 22 of the support element 2, for roughening the outer surface 22 and reaching a roughness Ra ranging from 1 to 8 μm. Such a roughness does not modify the final aspect of the coating, while enabling a better adhesion of the vitreous coating 3 on the support element 2.

The preparation of the coating composition comprises hydrolyzing and polycondensing of at least one silane of the general formula (I). In this formula, the groups X, which can be the same or different from each other, represent hydrolyzable groups or hydroxyl groups. Specific examples of hydrolyzable groups X are halogen atoms (particularly chlorine and bromine), alkoxy groups and acyloxy groups having up to 6 carbon atoms. Particularly the groups can include alkoxy groups, especially C₁-C₄ alkoxy groups such as methoxy, ethoxy and n- and i-propoxy. In one embodiment, groups X in a specific silane are identical, methoxy or ethoxy groups being employed.

The groups R in general formula (I) which for n=2 can be the same or different represent hydrogen, alkyl, alkenyl and alkynyl groups having up to 12 (generally up to 8 and particularly up to 4) carbon atoms and aryl, aralkyl and alkaryl groups having 6 to 10 carbon atoms.

Specific examples of such groups are methyl, ethyl, propyl and butyl, vinyl, allyl and propargyl, phenyl, tolyl, benzyl and naphthyl. Usually the groups R are unsubstituted.

Example groups R are (unsubstituted) alkyl groups having 1 to 4 carbon atoms, especially methyl and ethyl, as well as phenyl.

According to embodiments of the present invention, at least two silanes of the general formula (I) are employed. Such mixtures of silanes comprise, for example, at least one alkyltrialkoxy silane (e.g. (m) ethyltri (m) ethoxy silane or MTMS) and at least one tetraalkoxy silane (e.g. tetraethoxy silane TEOS).

The metal oxide particles, which can be employed in the methods of the invention in addition to the hydrolyzable silanes of the general formula (I), are similar to those described above. As already mentioned above, it can, however, be advantageous to employ micronized SiO₂ or Al₂O₃ particles, and preferably micronized SiO₂ particles.

Such micronized SiO₂ particles can, for example, be employed in the form of commercially available silica sols, that are notably obtainable from the company CLARIANT under the trade name KLEBOSOL, and from the company GRACE DAVISON under the trade name LUDOX. It is assumed that the presence of metal oxides particles in the coating is of essential importance for achieving sufficient layer thicknesses.

In addition to the presence of said metal oxide particles, the hydrolysis and polycondensation of the silane(s) of the general formula (I) can be carried out in the presence of at least one melting agent.

Examples of melting agents that can be used in embodiments of the present invention include compounds from the group of the methanoates (or formates) of alkali and alkaline earth metals, and boron trimethoxide (TMB), and their mixtures.

Said methanoates can be, for example, those of Li, Na, K, Mg, Ca and/or Ba. The use of alkali metal formates, especially of Na and K, is particularly preferred.

In the methods of the invention, hydrolysis and polycondensation of the silanes of the general formula (I) can take place in an alkaline medium, particularly in the case where metallic surfaces, which are not or only slightly resistant to the attack by acids (e.g. made of steel), are to be provided with a vitreous coating 3 according to embodiments of the present invention.

The hydrolysis and polycondensation of the silanes of the general formula (I) can be carried out in the presence or absence of an organic solvent. When using an organic solvent, the starting components can be soluble in the reaction medium, which usually includes water. Thus, the organic solvents that can be used the methods of the present invention include water-miscible solvents such as mono- or polyhydric alcohols (e.g. methanol, ethanol, and isopropyl alcohol), and glycols (e.g. hexylene glycols).

Other compounds, which function as chain-transfert agents (also usually called modifiers or regulators) can also optionally be added to the coating composition according to embodiments of the invention, in order to provide a viscosity which is suitable for the coating operation. Examples of chain-transfer agents which can be used in the coating composition of the invention include polyvinyl alcohol, silicone polyester resins, ethyl cellulose and waxes. These chain-transfer agents are to be removed during the step of thermally densifying the green protective coating.

It is also possible to incorporate one or more mineral pigment(s) directly into the coating composition to be employed according to embodiments of the present invention, for providing a colored vitreous protective 3 layer on the outer surface 22 of the support element 2. Said mineral pigment(s) are similar to those described above.

Otherwise, hydrolysis and polycondensation can be carried out according to modalities known to the skilled person.

With regard to the step of applying the coating composition according to embodiments of the invention on the outer surface 22 of the support element 2 (or on a portion of said outer surface 22, only), the coating composition can be applied according to conventional coating methods, such as, for example, spraying and screen printing.

The green protective coating 3 thus obtained generally has a thickness of at least 10 μm, and particularly from 10 to 20 μm. Said green coating 3 applied on at least a portion of the outer surface 22 will subsequently be thermally densified to form a vitreous layer.

Prior to said thermal densification, a conventional drying operation of the green protective coating 3 at room temperature and/or at slightly elevated temperature (e.g. at a temperature of up to 100° C., notably 80° C.) can be carried out.

According to methods of the invention, the thermally densification of the green or dried protective coating 3 is then carried out in a vacuum oven and comprises three steps including:

heating the frying pan 1 in air atmosphere (or under nitrogen atmosphere) at a heating rate of 5 K/minute to 30 K/minute, and particularly at 8 K/minute, to an end temperature ranging between 400 and 600° C., particularly ranging between 450° C. and 500° C., and more particularly about 480° C.

holding the frying pan 1 at said end temperature for at least two hours, and then cooling the frying pan 1 at a rate of approximately 5 to 20 K/minute, such as in this atmosphere, until removal from the oven.

It is recommended to carry out said thermal densification in a oxygen-free atmosphere, e.g. under nitrogen or argon, for reducing or avoiding oxidation of the non-covered portions of the outer surfaces 22. However, if the entire outer surface 22 is overlaid by the green protective coating 3, the oxygen free atmosphere is not necessary.

It remains to be noted that the thermal densification can optionally also be effected by IR or laser radiation. Also, it is possible to produce structured coatings by selective action of heat thereon.

According to embodiments of the present invention, the thickness of the vitreous layer 3 (e.g. the baked protective coating 3) obtained after the thermal densification can range from 10 μm to 15 μm.

Referring now to FIG. 2, the method of the present invention can comprise a step of applying and sintering a non-stick coating composition to the inner surface 21 of the support element 2, to provide a non stick coating 4 on said inner surface 21.

This non-stick coating is similar as those described above.

The examples which follow illustrate embodiments of the invention without restricting it.

Tests

Corrosion Test:

The aspect, notably the discoloration of the vitreous coating, is evaluated after 100 cycles of washings in a dishwasher using commercial detergents, like those provided by the Procter and Gamble Company under the trade name CASCADE®.

Micro-Scratch Test:

The Micro-Scratch Tester (MST) of ₊CSM

Instruments has been used to characterize the scratch resistance of the sol-gel protective coat. This technique involves generating a controlled scratch with a diamond tip on a sample coated by a sol-gel protective coat of different thicknesses (namely 5 mm, 7 μm and 15 μm).

The tip (either of diamond of sharp metal) having a diameter of 50 μm is dawn across the coated surface under progressive load, at a speed of 4 mm/s. At a certain critical load, the coating will start to fail.

Several loads can be measured by this device. The critical load corresponding to delamination of sol-gel coat from the substrate is given to define as scratch resistance of the coating.

Moreover, the value of scratch resistance, is evaluated for different thicknesses of sol gel coatings.

### EXAMPLE 1

Three-ply composite element, the outer surface of which is overlaid by a protective coating according to the invention.

a) Preparation of a Coating Sol

Chemicals used:
20% to 40% by weight of tetraethoxysilane (TEOS);
40% to 50% by weight of methyltrimethoxysilane;
2 l to 4 l of silica sol, with a content of SiO₂ between 10% and 40%;
0% to 40% by weight of micronized SiO₂ particles;
0% to 5% by weight of boron tritnethoxide (TMB);
0% to 5% by weight of sodium ethoxide;
0% to 5% by weight of potassium ethoxide;
0% to 5% by weight of sodium formate;
0% to 5% by weight of potassium formate;
0% to 5% by weight of aluminum acetylacetonate;
20% to 50% of ethanol, propanol, butylylycol, or hexyleneglycol;
Sodium hydroxide;
Anti-settling agents, surface modifiers, rheologic additives;
Optionally, A red mineral pigment IRIODIN® of the MERCK Company.

The silanes are initially charged and the silica sol added with vigorous stirring. Then, the sodium hydroxide is added at the start of the hydrolysis, at room temperature until all sodium hydroxide has dissolved and a clear solution is formed.

If the final protective coat is a colored one, the pigments are then introduced simultaneously with the melting agent.

Subsequently, water is slowly added dropwise at room temperature, resulting in a rise of the temperature of the solution.

After cooling to room temperature, it is filtered through a filter. The sol thus produced can be adjusted to a derived viscosity with a modifier.

b) Coating of a Triply Composite Element 2

The coating sol obtained in section a) is applied in a spraying process to the sandblasted outer surface 22 of the surface element 2 which is illustrated in FIG. 3.

After drying at room temperature, the coated element surface 2 is thermally densified in a forced air oven as follows:

first step: heating up to 480° C. at a heating rate of 10 K/min,

second step: hold time of at least four hours;

third step: cooling to room temperature at approximately 8 K/minute until removal from the oven. The film thickness is 15 μm.

The coating thus produced (without pigments) presents an improved scratch-resistance measured of 3.2N.

If the red pigments IRIODIN® have been previously introduced, the sol-gel coating thus produced presents an improved scratch-resistance measured of 3.96N, has a very uniform red color with a shiny metallic aspect and exhibits a discoloration below 5% as a proof of a high resistance to detergents used in the dishwashers (corrosion resistance).

The presence of pigments in the sol-gel coating enhances the scratch-resistance of the sol-gel coating of the invention.

### COMPARATIVE EXAMPLE 1

Three-ply composite element, the outer surface of which is overlaid by the same sol-gel coating as in example 1, but with a lower thickness (5 μm).

The same coating of example 1 has been produced according to the same process. The only difference with the sol-gel coating of example 1 is the final thickness of the coating: 5 μm.

Such a coating (thickness of 5 μm, without pigments) presents an improved scratch-resistance measured of 1.96N.

The concentration of the pigments in the coating is also the same as in Example 1. When the red pigments IRIODIN® have been previously introduced, the sol-gel coating thus produced (thickness of 5 μm, with pigments) presents an improved scratch-resistance measured of 2.27N.

However, this sol-gel coating exhibits a coloration which is not sufficient and not uniform. This can be explained by the fact that one the dimensions of the pigments (in the form of flakes) is too large (5 to 50 μm) compared to the thickness of the coating.

### COMPARATIVE EXAMPLE 2

Three-ply composite element, the outer surface of which is overlaid by the same sol-gel coating as in example 1, but with a lower thickness (7 μm).

The same coating of example 1 has been produced according to the same process. The only difference with the sol-gel coating of example 1 is the final thickness of the coating: 7 μm. Such a coating (thickness of 7 μm, without pigments) presents an improved scratch-resistance measured of 2.31N.

The concentration of the pigments in the coating is also the same as in Example 1. When the red pigments IRIODIN® have been previously introduced, the sol-gel coating thus produced (thickness of 7 μm, with pigments) presents an improved scratch-resistance measured of 3.16N.

However, this sol-gel coating exhibits a coloration which is not sufficient and not uniform. This can be explained by the fact that one the dimensions of the pigments (in the form of flakes) is too large (5 to 50 μm) compared to the thickness of the coating.

### COMPARATIVE EXAMPLE 3

Three-ply composite support element 2, the outer surface of which is overlaid by a conventional enamel.

A conventional enamel, which is suitable for an application to a stainless-steel substrate, is applied by a spraying process to the outer surface 22 of the surface element 2, which is illustrated in FIG. 3.

The enamel coating thus produced presents a hardness of 5 Mohs. However, the enamel is thermally densified by heating up to 800° C. or more, which necessarily leads to the melting of the core aluminium layer 24 and give unacceptable distortion of the support.

### COMPARATIVE EXAMPLE 4

Three-ply composite support element, the outer surface of which is overlaid by a conventional paint.

A conventional paint is applied to the sandblasted outer surface 22 of the surface element 2.

This coating presents a corrosion resistance similar to that obtained with the vitreous coating of example 1 and a hardness in the range of 3-4 Mohs. However, the direct contact of this covered three-ply support element is proscribed.

1. A composite cookware for a food preparation, comprising:
a hollow support element, defining a bottom and a side wall rising from said bottom, said support element having an inner surface adapted to be oriented towards the food to be disposed in the cookware, and an outer surface adapted to be oriented downwardly towards a heat source; and
a proactive coat overlaying the outer surface of the support element, said protective coat being a continuous film having a thickness of at least 10 μm and formed of a sol-gel material, the sol-gel material comprising a matrix of at least one polyalcoxysilane and at least one metal oxide dispersed in said matrix, said sol-gel material having a coefficient of expansion α, ranging from 50.10⁻⁷ to 100.10⁻⁷ K⁻¹;
wherein said support element is a composite element comprising an outer layer of stainless steel having said outer surface, and an inner layer formed of a metal or a metal alloy having a melting temperature below 650° C., said inner layer being bonded to the outer layer of stainless steel.

2. The cookware according to claim 1, wherein the inner layer is a layer of pure aluminum or aluminum alloy.

3. The cookware according to claim 1, wherein the inner layer is further bonded to a second layer of stainless steel.

4. The cookware according to claim 1, wherein the outer layer of stainless steel is a ferromagnetic grade adapted to render the cookware suitable for induction heating.

5. The cookware according to claim 1, wherein the support element is a multi-ply composite element, in which the outer layer completely covers the inner layer.

6. The cookware according to claim 4, wherein the outer layer is a plate centered on the bottom and only covering the portion of the inner layer defined by said bottom.

7. The cookware according to claim 1, wherein the outer layer of stainless steel has one of a brushed or a sandblasted finish on the outer surface.

8. The cookware according to claim 1, wherein the protective coat has a thickness between 10 μm and 15 μm.

9. The cookware according to claim 1, wherein the metal oxide of the sol-gel material is chosen from silica, aluminum, zircon oxide, vanadium oxide, and cerium oxide.

10. The cookware according to claim 1, wherein the protective coat comprises at least one mineral pigment.

11. The cookware according to claim 10, wherein the pigment is a micronized or a submicronized pigment.

12. The cookware according to claim 10, wherein the pigment is chosen from metal oxides, spinels, flakes of mica or flakes of alumina wherein said flakes of mica or flakes of alumina are covered by metal oxides.

13. The cookware according to claim 12, wherein the metal oxide pigment is at least one of titanium oxide (TiO₂) and iron oxide (Fe₂O₃).

14. The cookware according to claim 12, wherein the metal oxides covering the flakes of mica or the flakes of aluminum are chosen from oxides of zircon, titanium and tin.

15. The cookware according to claim 1, wherein the inner surface of the support element is innerly overlaid by a non-stick layer applied thereto.

16. The cookware according to claim 15, wherein the nonstick layer comprises a sintered network of at least one thermostable resin withstanding a temperature of at least 200° C.

17. The cookware according to claim 16, wherein the thermostable resin is a silicone resin or a fluorocarbon resin.

18. A method for manufacturing a composite cookware for a food preparation, the method comprising:
providing a hollow support element defining a bottom, and a side wall rising from said bottom, said support element having an inner surface adapted to be oriented towards the food to be disposed in the cookware and an outer surface adapted to be downwardly oriented towards a heat source;
preparing a coating composition;
coating at least a portion of the outer surface of the support element with the coating composition to form a uncured protective coating on said outer surface; and
thermally densifying the uncured protective coating to form a transparent vitreous protective coating on said outer surface,
wherein
the metal support element is a composite element comprising an outer layer of stainless steel having said outer surface, and an inner layer of a metal or a metal alloy having a melting temperature below 650° C., said inner layer being bonded to said outer layer and wherein
the coating composition is prepared by a process comprising hydrolyzing and polycondensing at least one silane of the general formula:
RₙSiX₄₋ₙ
wherein
each R, which are the same or different from each other, is hydrogen or an optionally fluorinated alkyl, alkenyl, or alkynyl group having up to 12 carbon atoms, or an optionally fluorinated aryl, aralkyl, or alkaryl group having 6 to 10 carbon atoms,
each X, which are the same or different from each other, is a hydrolyzable group or a hydroxyl group, and
n is 0, 1 or 2, provided that at least one silane has n=1 or 2, or one or more oligomers derived therefrom, in the presence of at least one metal oxide and at least one melting agent selected from the group consisting of the oxides and hydroxides of alkali and alkaline earth metals and boron trimethoxide, wherein the weight ratio of the total Si in the silanes to the melting agent is between 5 and 20 and
wherein thermally densifying the protective coating is carried out at an end temperature ranging between 400 and 600° C.

19. The method according to claim 18, wherein the outer layer is a plate centered on the bottom of the cookware and covering the portion of the inner layer defined by said bottom, said plate being applied to the inner layer by stamping, said stamping being carried out before coating the outer surface with the coating composition.

20. The method according to claim 18, wherein an end temperature of thermally densifying the protective coating ranges between 450° C. and 500° C.

21. The method according to claim 18, wherein the metal oxide is SiO₂ or Al₂O₃.

22. The method according to claim 18, wherein the or each X is alkoxy.

23. The method according to claim 22, wherein said at least one silane is chosen from methyltrimethoxysilane (MTMS), methytriethoxysilane (MTEOS), ethyltrimethoxysilane, ethyltriethoxysilane, tetramethoxysilane and tetraethoxysilane (TEOS).

24. The method according to claim 18, wherein the melting agent is selected from sodium formate, potassium formate, boron trimethoxide (TMB), and mixtures thereof.

25. The method according to claim 18, wherein the coating composition comprises at least one mineral pigment for providing a colored vitreous protective layer on the outer surface of the support element.

26. The method according to claim 18, further comprising brushing or sandblasting the outer surface of the support element before applying the coating composition.

27. The method according to claim 18, further comprising applying and sintering a non-stick coating composition to the inner surface of the support element to provide a non stick coating on said inner surface.

28. The method of claim 22, wherein the or each X is methoxy.

29. The method of claim 25, wherein the at least one mineral pigment comprises a submicron pigment.
